(19) United States
(12) Patent Application Publication
(10) Pub. No.: US 2007/0019312 A1
(43) Pub. Date: Jan. 25, 2007

(54) Auxiliary rearview mirror mounting arrangement

(76) Inventor: Tsai-Fu Hu, Tainan (TW)

Correspondence Address: PRO-TECHTOR INTERNATIONAL SERVICES, 20775 NORADA CT., SARATOGA, CA, 95070, US

(21) Appl. No.: 11/234,666

(22) Filed: Sep. 23, 2005

(30) Foreign Application Priority Data
Jul. 19, 2005 (TW) 94124237

(51) Int. Cl. G02B 7/182

(52) U.S. Cl. 359/871; 296/1.11

(57) ABSTRACT

An auxiliary rearview mirror mounting arrangement is disclosed to include two fasteners for securing the two support arms of an auxiliary rearview mirror to a vehicle rearview mirror, each fastener having two straps, two connecting members respectively provided at one end of each of the two straps for securing the straps to the support arms of the auxiliary rearview mirror, and a clip for adjustably joining the other ends of the straps to secure the straps to the vehicle rearview mirror.

### BACKGROUND OF THE INVENTION

1. Field of the Invention

The present invention relates to the mounting of an auxiliary rearview mirror and more particularly, to an auxiliary rearview mirror mounting arrangement, which uses two fasteners to adjustably secure an auxiliary rearview mirror to a vehicle rearview mirror.

2. Description of the Related Art

FIG. 1 shows an auxiliary rearview mirror 40 fastened to the vehicle rearview mirror 30 of a motor vehicle 10. Referring to FIG. 2 and FIG. 1 again, the auxiliary rearview mirror 40 has a connector 50 provided at the back side, two support arms 60 respectively pivoted to the connector 50, and two fastening straps 70 that secure the support arms 60 to the vehicle rearview mirror 30 (see FIG. 4). Alternatively, the aforesaid connector 50 can be eliminated, and the support arms 60 can be directly pivoted to the auxiliary rearview mirror 40 (see FIG. 3). The fastening straps 70 each have a retaining portion 701 disposed at one end and fastened to a respective mounting hole 601 at one support arm 60 (see FIG. 2 and FIG. 3), and a strap fitting 801 adjustably provided at the other end and fastened to a respective hook 602 at the other support arm 60. Further, each support arm 60 is provided with substantially L-shaped retaining frames 603 for hooking on the rim 301 of the vehicle rearview mirror 30 (see FIG. 4). According to this design, the L-shaped retaining frames 603 have a fixed height and fit only one particular model of vehicle rearview mirror that has a predetermined thickness of rim. If the thickness of the rim 301 of the vehicle rearview mirror 30 does not fit the height of the L-shaped retaining frames 603, the auxiliary rearview mirror 40 may vibrate relative to or fall from-the vehicle rearview mirror 30 during running of the motor vehicle 10.

### SUMMARY OF THE INVENTION

The present invention has been accomplished under the circumstances in view. It is therefore the main object of the present invention to provide an auxiliary rearview mirror mounting arrangement, which secures firmly the auxiliary rearview mirror to the vehicle rearview mirror against vibration. It is another object of the present invention to provide an auxiliary rearview mirror mounting arrangement, which fits any of a variety of vehicle rearview mirrors. To achieve these and other objects of the present invention, the auxiliary rearview mirror mounting arrangement comprises an auxiliary rearview mirror, which has at least one support arm, at least one fastener for fastening the auxiliary rearview mirror to a vehicle rearview mirror. Each fastener comprises a first strap that has a first end and a second end, a second strap that has a first end and a second end, a first connecting member and a second connecting member respectively provided at the first end of the first strap and the first end of the second strap for securing the first strap and the second strap to the at least one support arm of the auxiliary rearview mirror, and a clip coupled to the second end of the second strap and adjustably clamped on the second end of the first strap to join the second end of the first strap and the second end of the second strap.

The connecting members of each fastener can be hooks or hook holes, and each support arm of the auxiliary rearview mirror has hook holes or hooks for receiving the connecting members.

Further, the first strap has a plurality of transverse teeth arranged along the length thereof and sloping in one direction; the clip of each fastener comprises a base frame, which has two front lugs and two rear lugs arranged at two sides, an actuating block, which is pivotally connected between the front lugs and has a front push end for pushing the transverse teeth of first strap forward upon insertion of the second end of the first strap into the clip, an engagement block pivotally connected between the rear lugs for engaging the transverse teeth of the strap to lock the first strap to the clip, and two torsional springs respectively coupled between the base frame and the actuating block and between the base frame and the engagement block to impart a biasing force to the actuating block and the engagement block respectively.

Further, each support arm of the auxiliary rearview mirror comprises at least one horizontal front insertion hole, at least one vertical rear insertion hole corresponding to the at least one horizontal front insertion holes, at least one vertical sliding track respectively upwardly disposed adjacent to the at least one vertical rear insertion hole, and at least one flexible connecting member for securing the straps of each fastener to each support arm of the auxiliary rearview mirror. The at least one flexible connecting member each has a rear end respectively slidably coupled to the at least one vertical sliding track and a front end respectively inserted through the at least one vertical rear insertion hole and then the at least one horizontal front insertion hole of the at least one support arm, and a hook at the rear end for hooking on the rim of the vehicle rearview mirror.

### BRIEF DESCRIPTION OF THE DRAWINGS

FIG. 1 illustrates an auxiliary rearview mirror installed in a vehicle rearview mirror on a motor vehicle according to the prior art.

FIG. 2 is an elevational view of an auxiliary rearview mirror mounting structure according to the prior art.

FIG. 3 is an elevational view of another design of auxiliary rearview mirror mounting structure according to the prior art.

FIG. 4 is a schematic drawing showing the prior art auxiliary rearview mirror mounting structure installed in a vehicle rearview mirror.

FIG. 5 is an exploded view of an auxiliary rearview mirror mounting structure according to the present invention.

FIG. 5A corresponds to a part of FIG. 5, showing an alternate form of the connection between the connecting member at one strap of the fastener and the connecting member at the support arm.

FIG. 6 is substantially similar to FIG. 5 but showing an alternate form of the support arms.

FIG. 6A corresponds to a part of FIG. 6, showing an alternate form of the connection between the connecting member at one strap of the fastener and the connecting member at the support arm.

FIG. 7 is an exploded view showing still another alternate form of the support arms of the auxiliary rearview according the present invention.

FIG. 8 is a sectional assembly view of the fastener according to the present invention.

FIG. 9 is a schematic drawing showing the operation of the clip of the fastener according to the present invention (I).

FIG. 10 is a schematic drawing showing the operation of the clip of the fastener according to the present invention (II).

FIG. 11 is a schematic drawing showing the operation of the clip of the fastener according to the present invention (III).

FIG. 12 is a schematic drawing showing an installation example of the present invention.

FIG. 13 is a schematic drawing showing another installation example of the present invention.

FIG. 13A is an enlarged view of a part of FIG. 13.

FIG. 14 is a schematic drawing showing still another installation example of the present invention.

FIG. 15 is an exploded view showing the use of the fastener with still another structure of auxiliary rearview mirror according to the present invention.

FIG. 16 is an exploded view showing the use of the fastener with still another structure of auxiliary rearview mirror according to the present invention.

FIG. 17 is an exploded view showing the use of the fastener with still another structure of auxiliary rearview mirror according to the present invention.

FIG. 17A is an exploded view showing still another alternate form of the connection between the straps of the fastener and the support arm of the auxiliary rearview mirror according to the present invention.

FIG. 17B is an exploded view showing still another alternate form of the connection between the straps of the fastener and the support arm of the auxiliary rearview mirror according to the present invention.

FIG. 18 is an exploded view showing the use of the fastener with still another structure of auxiliary rearview mirror according to the present invention.

FIG. 18A corresponds to a part of FIG. 18 but showing an alternate form of the connection between one strap of the fastener and one support arm of the auxiliary rearview mirror.

FIG. 19 is an exploded view showing still another alternate of the vehicle rearview mirror and auxiliary rearview mirror according to the present invention.

FIG. 20 is a schematic side assembly view of the assembly shown in FIG. 19;

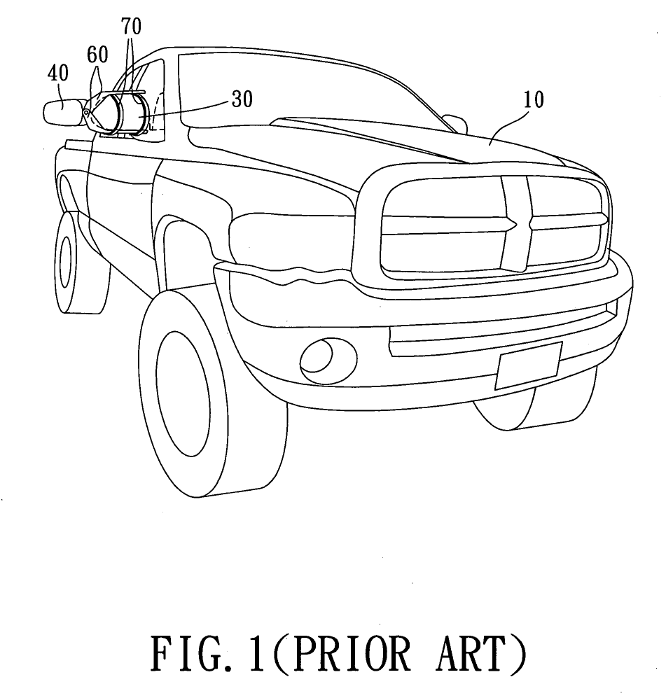

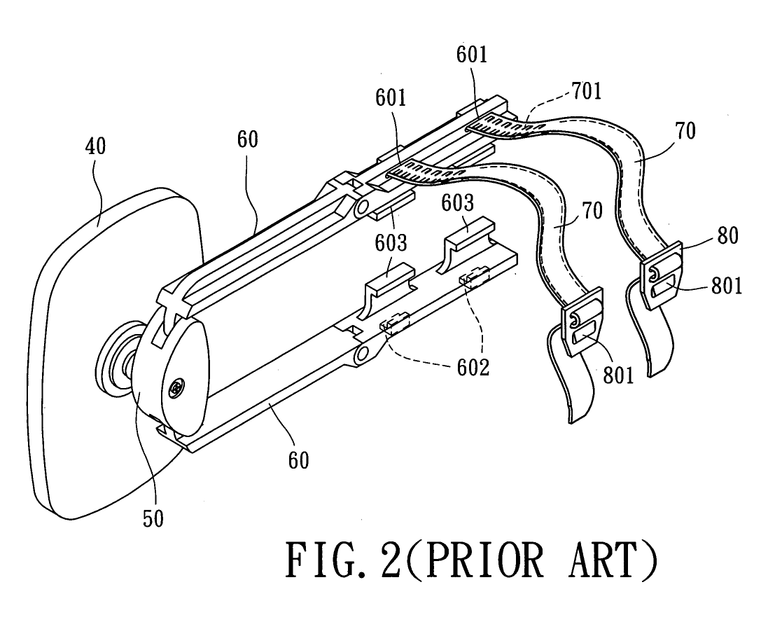

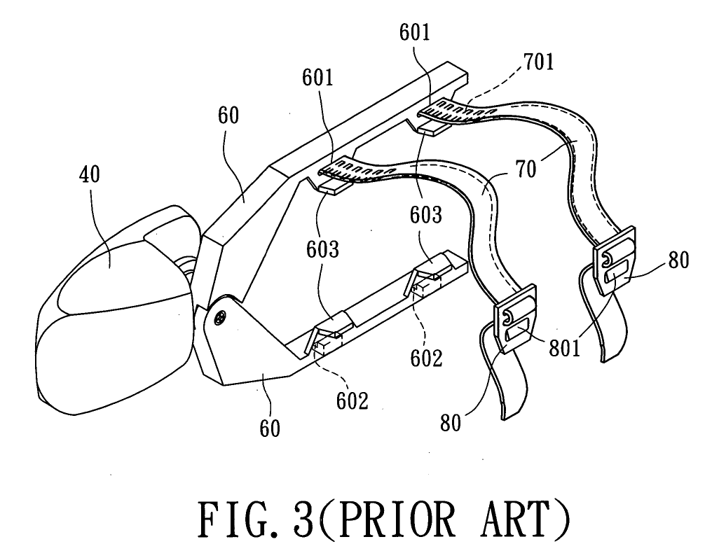

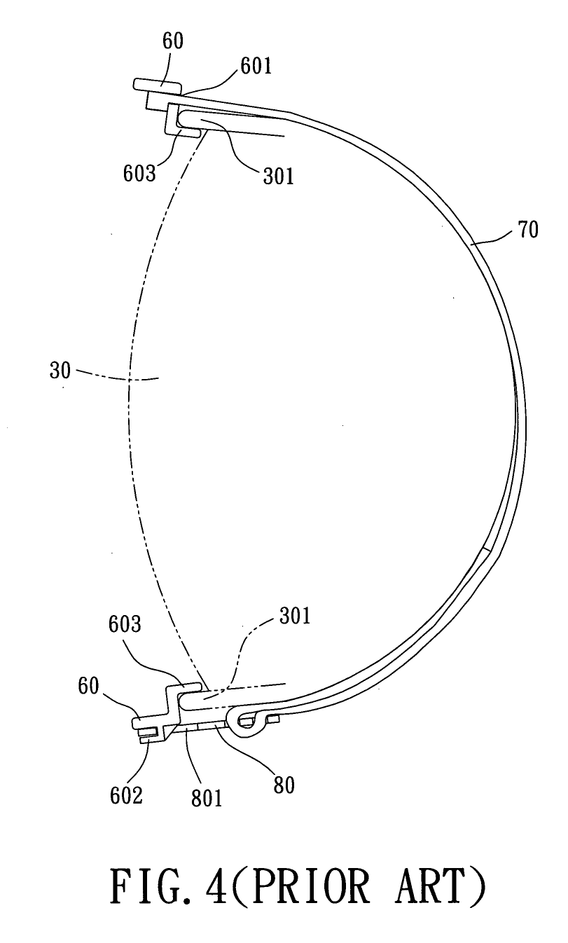

### DETAILED DESCRIPTION OF THE PREFERRED EMBODIMENT

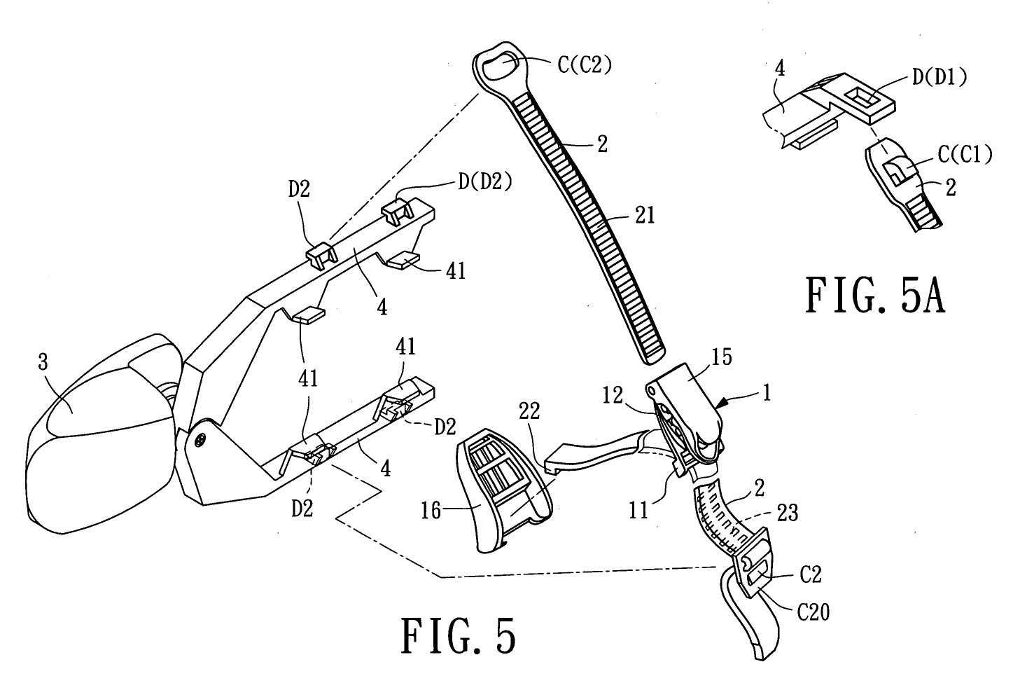

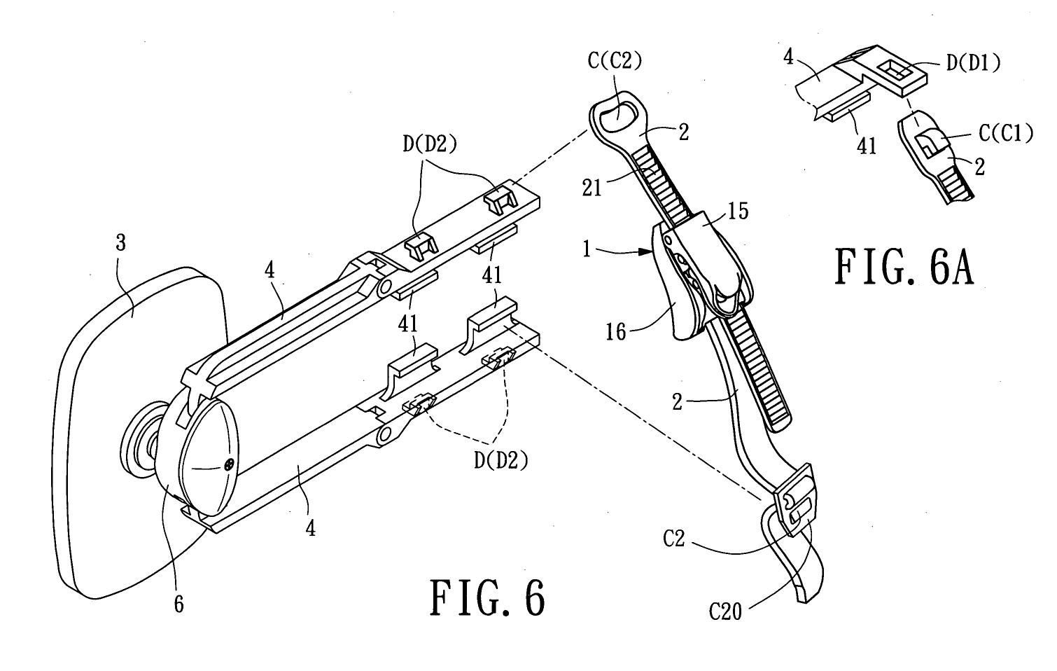

Referring to FIGS. 5 and 6, a fastener for fastening an auxiliary rearview mirror to a vehicle rearview mirror in accordance with the present invention is shown comprised of a clip 1 and two straps 2.

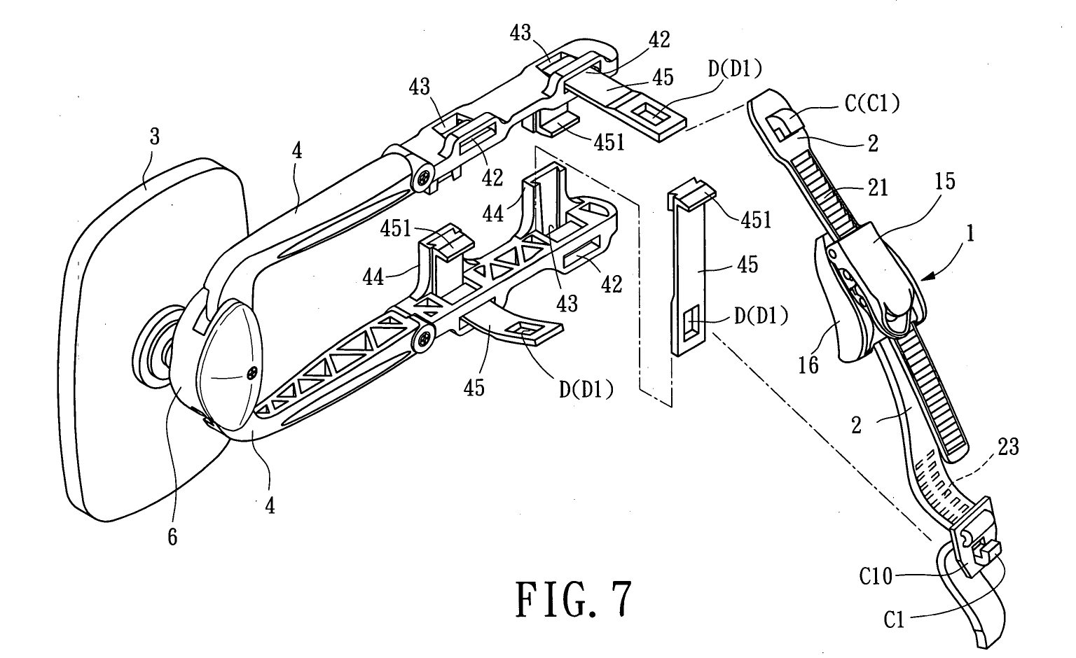

The clip 1 has a locating ring 11. The straps 2 have a connecting member C at one end. The connecting member C can be a hook C1 (see FIGS. 5A and 6A), or hook hole C2 (see FIG. 5). The hook C1 may be formed integral with a strap fitting C10 at one strap 2 (see FIG. 7). The hook hole C2 may be formed on a strap fitting C20 at one strap 2 (see FIGS. 5 and 6). One of the straps 2 has transverse teeth 21 arranged on the top wall along the length and sloping in one direction. The other of the straps 2 has a retaining endpiece 22 and anti-slip ribs 23 on the respective bottom wall (see FIG. 5). The strap 2 that has the retaining endpiece 22 is inserted through the locating ring 11 of the clip 1 with the retaining endpiece 22 stopped at the locating ring 11. The clip 1 is axially slidably mounted on the strap 2 that has the transverse teeth 21, and clamped on the transverse teeth 21 at the desired location. When unfastening the clip 1, the user can move the strap 2 that has the transverse teeth 21 relative to the clip 1 to adjust the combined length of the straps 2.

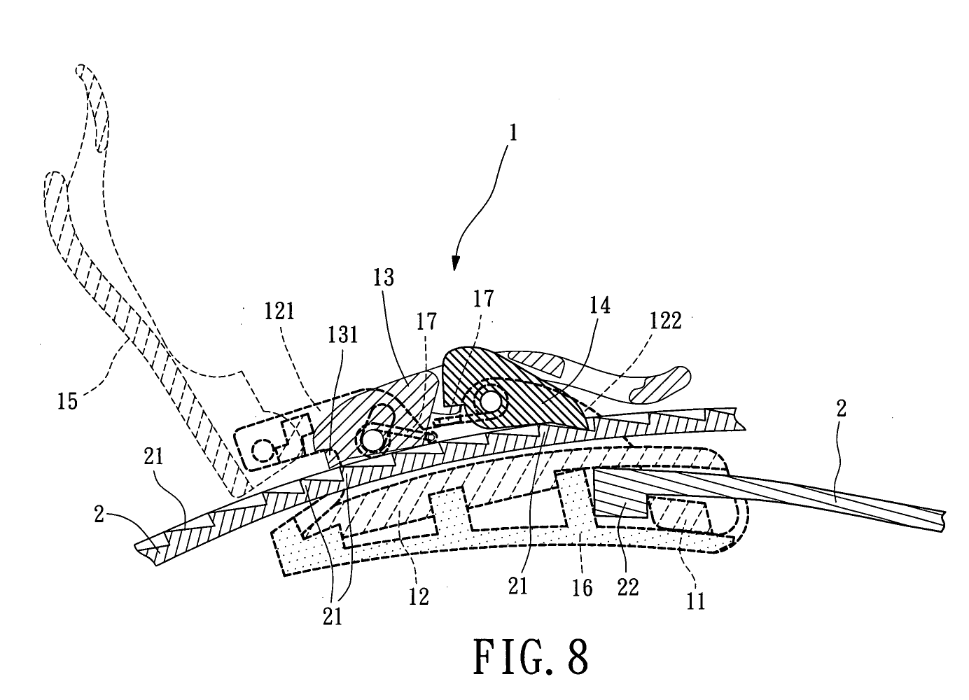

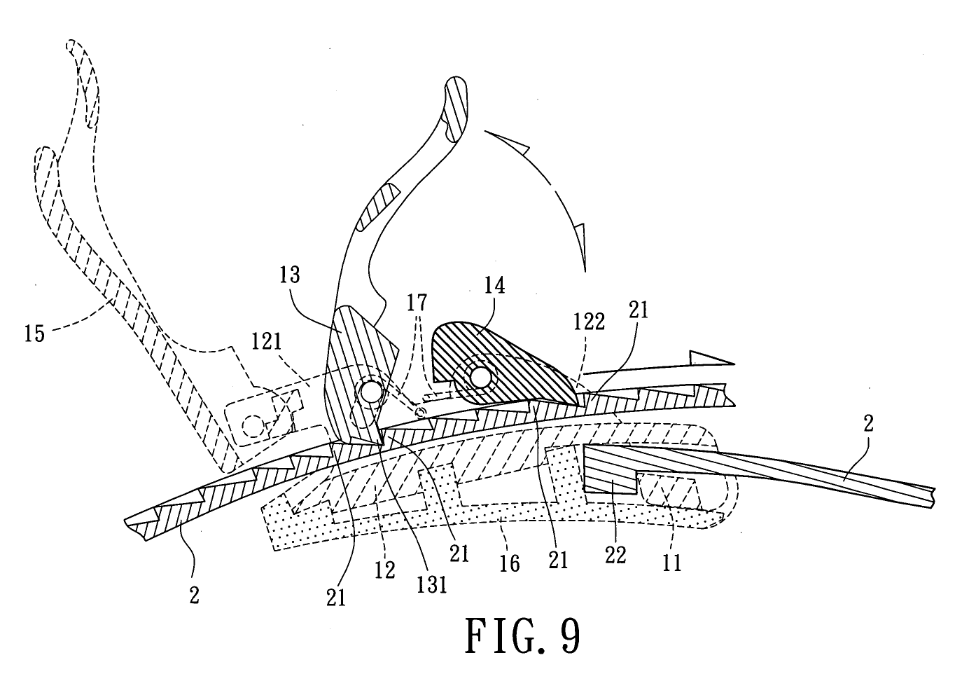

Referring to FIGS. 8 and 9, the clip 1 comprises a base frame 12, which has two front lugs 121 and two rear lugs 122 arranged at two sides, an actuating block 13, which is pivotally connected between the front lugs 121 and has a front push end 131, an engagement block 14 pivotally connected between the rear lugs 122, a cover 15 pivoted to the front lugs 121 and adapted to cover the actuating block 13 and the engagement block 14, a cushion block 16 fastened to the bottom side of the base frame 12, and two torsional springs 17 respectively coupled between the base frame 12 and the actuating block 13 and between the base frame 12 and the engagement block 14. The aforesaid locating ring 11 is formed integral with one end of the base frame 12.

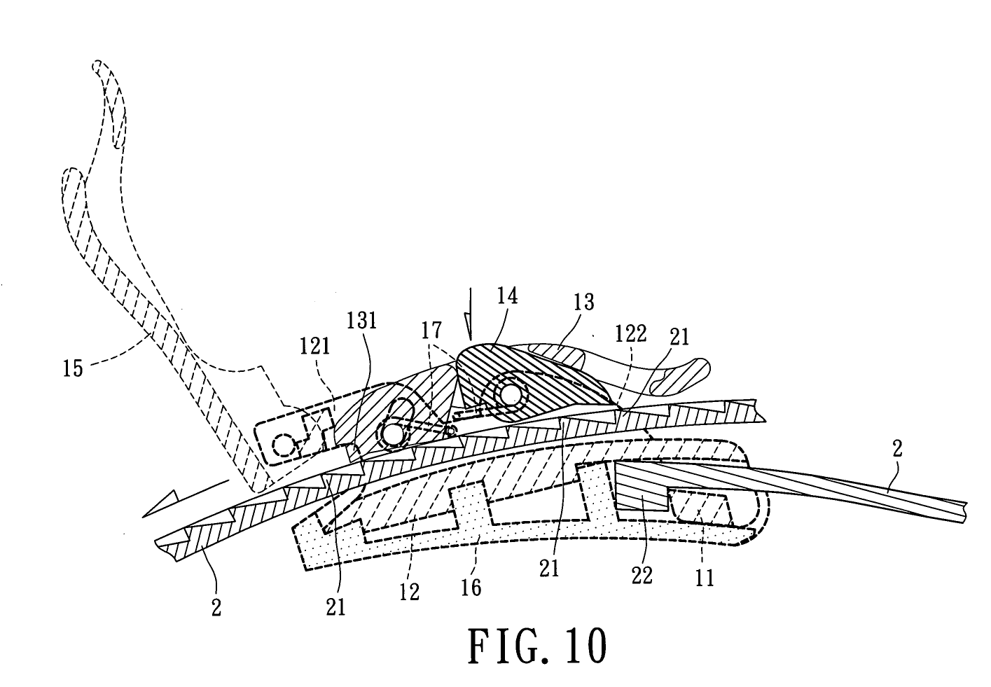

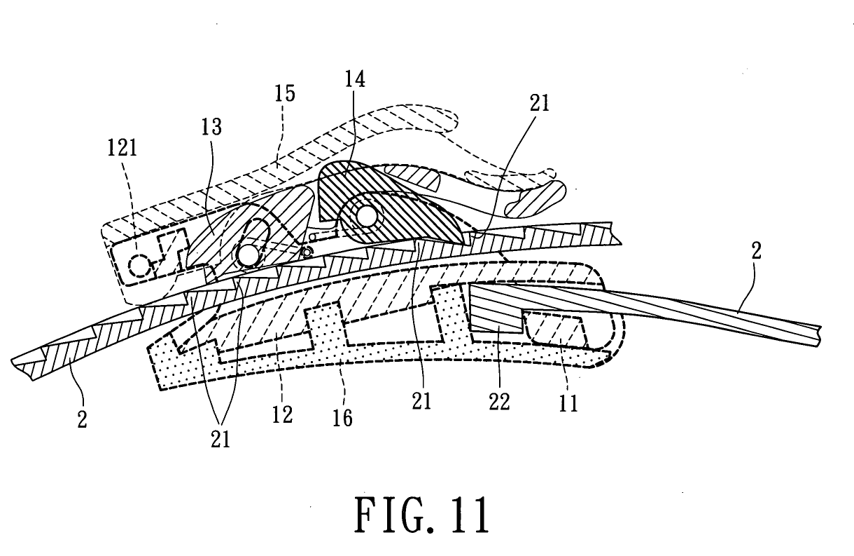

Referring to FIGS. 9˜11, when the strap 2 that has the transverse teeth 21 is inserted through the gap between the base frame 12 and the actuating block 13 and engagement block 14, the actuating block 13 and the cover 15 are turned relative to the base frame 12 in one direction, and the front push end 131 of the actuating block 13 allows the transverse teeth 21 to pass (see FIG. 9). When the inserting force is disappeared, the engagement block 14 is stopped against one transverse tooth 21 of the respective strap 2 to prohibit backward movement of the respective strap 2 relative to the clip 1 (see FIG. 8). Before lifting the actuating block 13 and pressing the engagement block 14, the user can pull the strap 2 out of the clip (see FIG. 10). Further, when the cover 15 is closed, it blocks the engagement block 14 (see FIG. 11), preventing the engagement block 14 from be forced by an external pressure accidentally to disengage the strap 2.

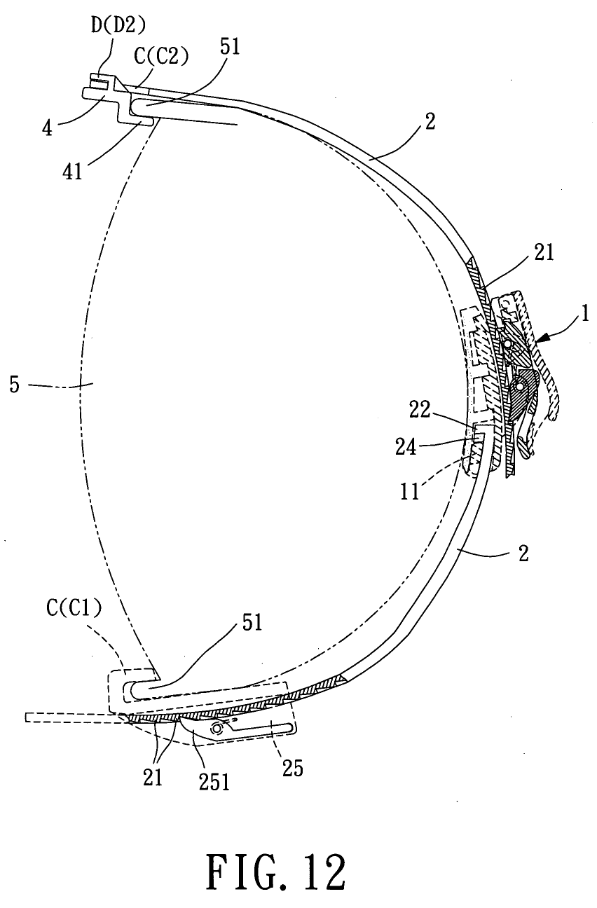

Further, the strap 2 that has the transverse teeth 21 is made of a hard material, for example, engineering plastics. The other strap 2 is made of a flexible material, for example, rubber. Alternatively, both straps 2 can be made of engineering plastics. In this case, the retaining endpiece 22 is covered with a flexible cap 24 (seed FIG. 12) that is compressible during mounting of the fastener.

According to the embodiment shown in FIG. 12, the strap 2 having the said retaining endpiece 22 also has transverse teeth 21 arranged on the top wall along the length and sloping in one direction, and the respective connecting member C (hook C1 or hook hole C2) is formed integral with a slide 25, which is coupled to the respective strap 2 and has a spring-supported locking lever 251 for engaging the transverse teeth 21 to lock the slide 25 to the respective strap 2 at the desired location.

Further, the auxiliary rearview mirror 3 comprises a swivel connector 6 rotatably provided at the back side, and two support arms 4 pivotally connected to the swivel connector 6 (see FIG. 6). Each support arm 4 has connecting members D, for example, hook holes D1 (see FIGS. 5A and 6A) or hooks D2 (see FIGS. 5 and 6) for the connection of the connecting members C (hooks C1 or hook holes C2) of the straps 2 of the respective fasteners, and L-shaped hooking lugs 41.

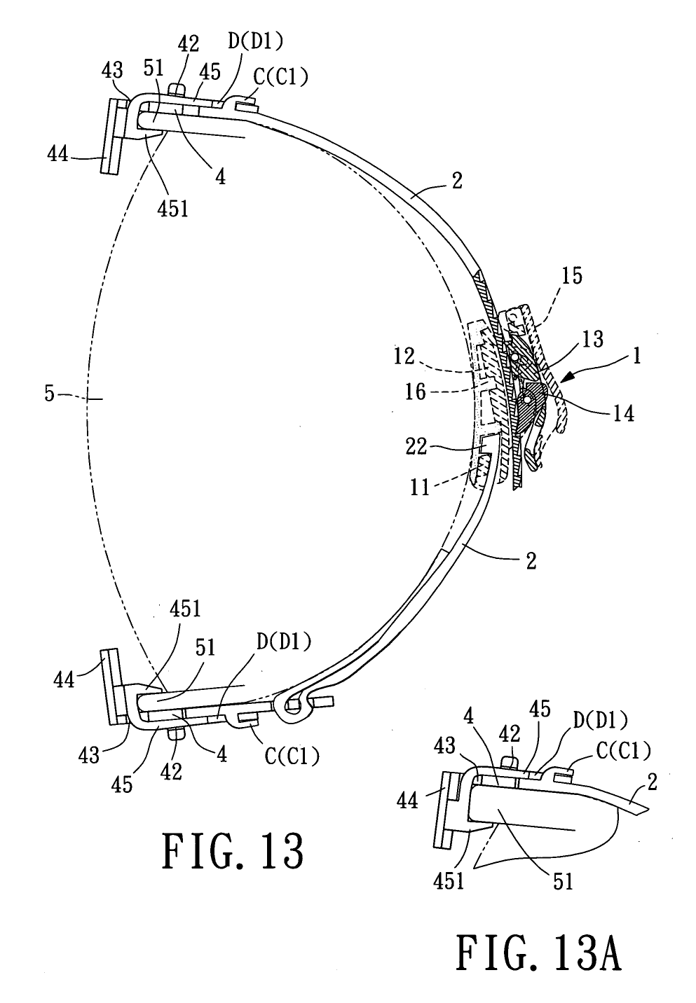

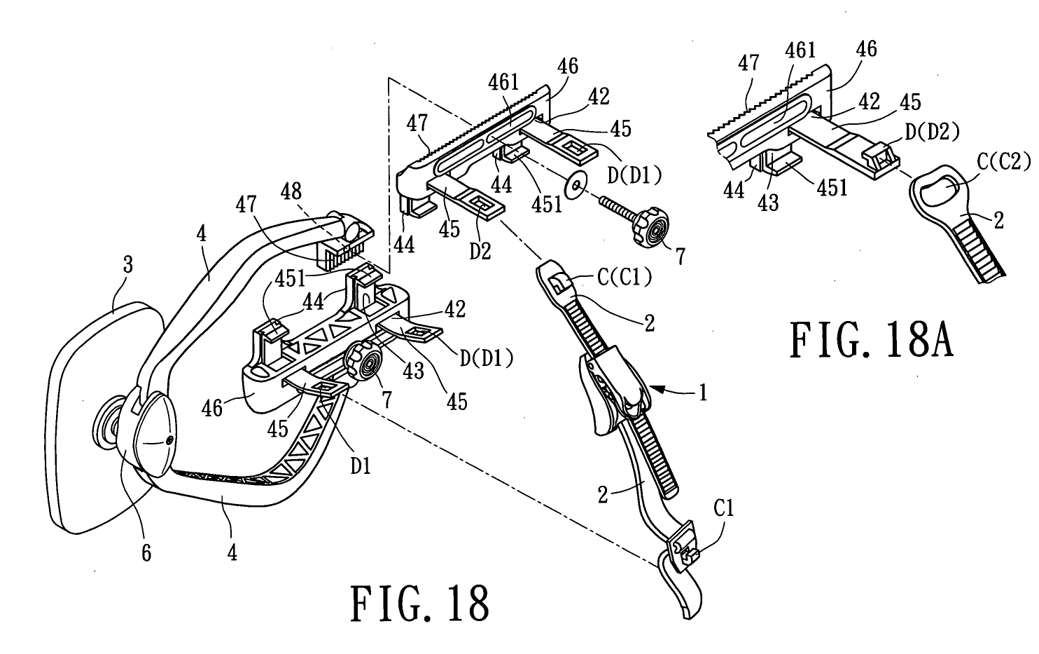

The support arms 4 each further have two horizontal front insertion holes 42, two vertical rear insertion holes 43 corresponding to the horizontal front insertion holes 42, two vertical sliding tracks 44 respectively upwardly disposed adjacent to the vertical rear insertion holes 43. Further, two flexible connecting members 45 are provided for securing the straps 2 of two fasteners to the support arms 4. The vertical sliding tracks 44 can be a dovetail track or the like. The flexible connecting members 45 each have one end, namely, the rear end respectively slidably coupled to the vertical sliding tracks 44 and the other end, namely, the front end respectively inserted through the vertical rear insertion holes 43 and then the horizontal front insertion holes 42 of the respective support arms 44. Further, each flexible connecting member 45 has a hook 451 at the rear end for hooking on the rim 51 of the vehicle rearview mirror 5 (see FIG. 13) and a retaining portion D, for example, a hook hole D1 (see FIG. 7) or hook D2 (see FIG. 18A) at the front end for receiving the respective straps 2 of the respective fasteners. The flexible connecting members 45 can be moved relative to the vertical sliding tracks 44 to fit the thickness of the rim 51 of the vehicle rearview mirror 5 (see FIGS. 13 and 13A).

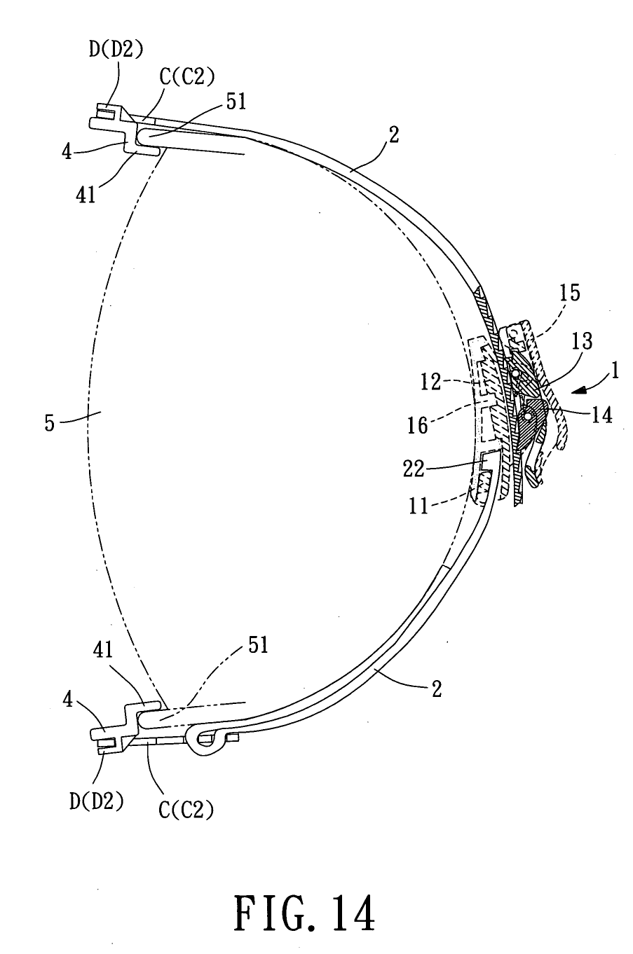

During installation, the hooks C1 or hook holes C2 of the straps 2 are respectively fastened to the hook holes D1 (see FIGS. 5A and 6A) or hooks D2 (see FIGS. 5 and 6) of the flexible connecting members 45, and the L-shaped hooking lugs 41 are hooked on the rim 51 of the vehicle rearview mirror 5 (see FIG. 14). By means of repeatedly operating the actuating block 13 of the clip 1 of each fastener, the combined length of the straps 2 of each fastener is shortened (see FIG. 9) to fit the size of the vehicle rearview mirror 5 so that the auxiliary rearview mirror 3 is positively secured to the vehicle rearview mirror 5 and will not vibrate during movement of the motor vehicle. When fastening up the fasteners, the engagement block 14 of the clip 1 of each fastener engages one transverse tooth 21 to lock the respective strap 2 (see FIGS. 8 and 11), and the fasteners impart a pull force to the flexible connecting members 45, thereby enhancing the engagement between the hooks 451 and the rim 51 of the vehicle rearview mirror 5. When pressed the front end of the engagement block 14 of the clip 1, the clip 1 is disengaged from the respective strap 2 (see FIG. 10), and the respective fastener is loosened.

During installation of the auxiliary rearview mirror 3 of which each support arm 4 is equipped with flexible connecting members 45, the user can operate the actuating block 13 of the clip 1 of each fastener to adjust the combined length of the respective straps 2 and at the same time to move the respective flexible connecting members 45 relative to the respective vertical sliding tracks 44 so as to fit the thickness of the rim 51 of the vehicle rearview mirror 5 (see FIGS. 13 and 13A).

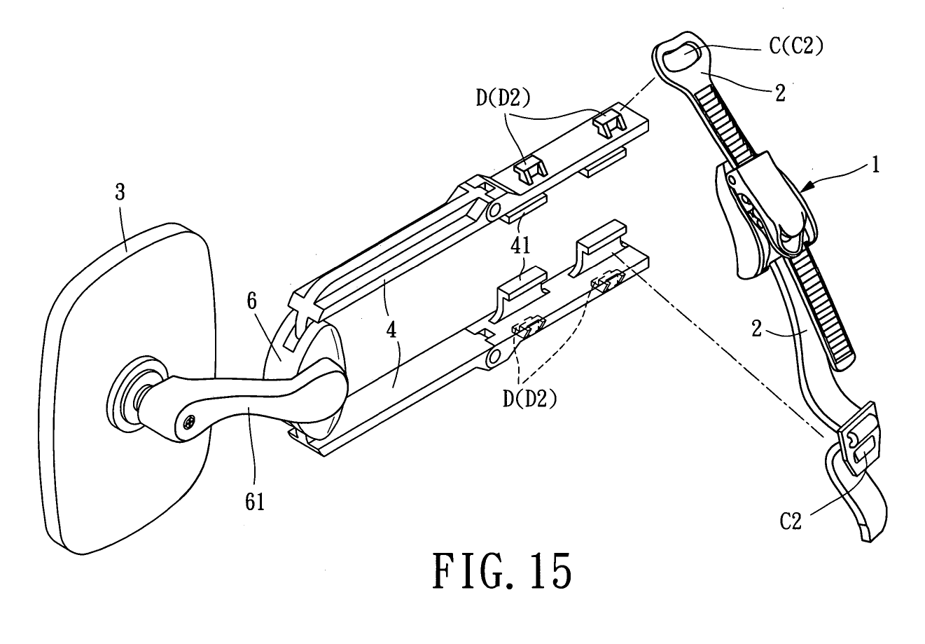

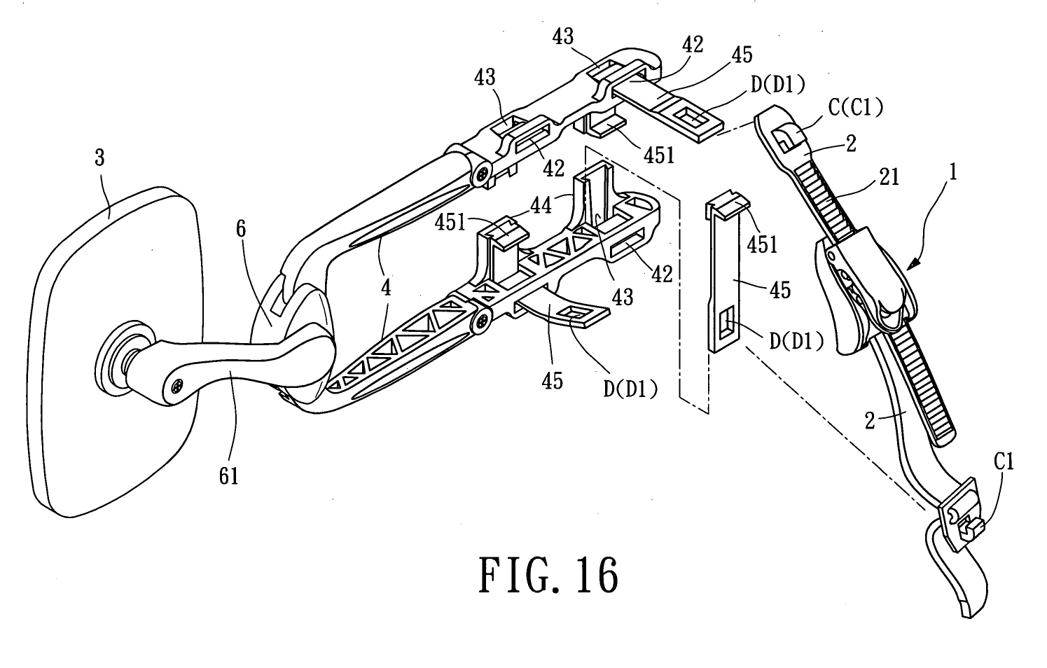

The embodiment shown in FIG. 15 is substantially similar to the embodiment shown in FIGS. 5 and 6 with the exception that the a connecting bar 61 is pivotally connected between the auxiliary rearview mirror 3 and the swivel connector 6 to extend the length of the whole assembly of the auxiliary rearview mirror 3. The embodiment shown in FIG. 16 is substantially similar to the embodiment shown in FIG. 7 with the exception that the a connecting bar 61 is pivotally connected between the auxiliary rearview mirror 3 and the swivel connector 6 to extend the length of the whole assembly of the auxiliary rearview mirror 3.

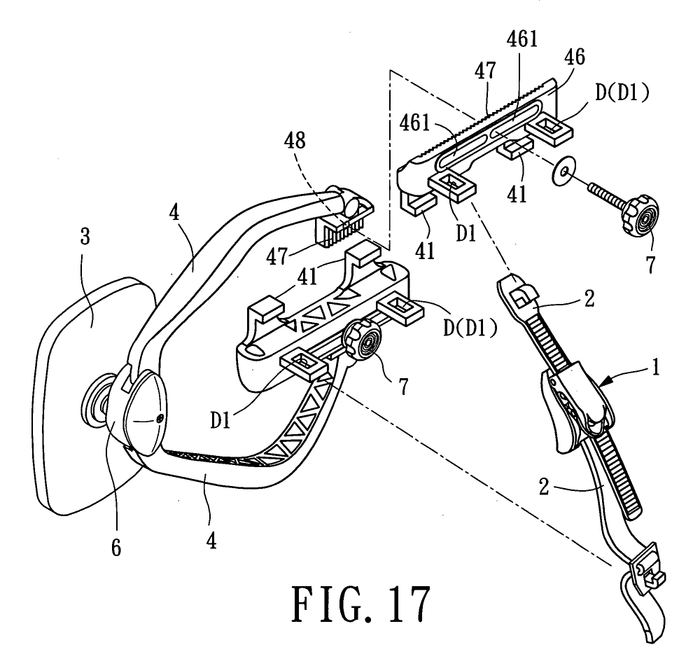

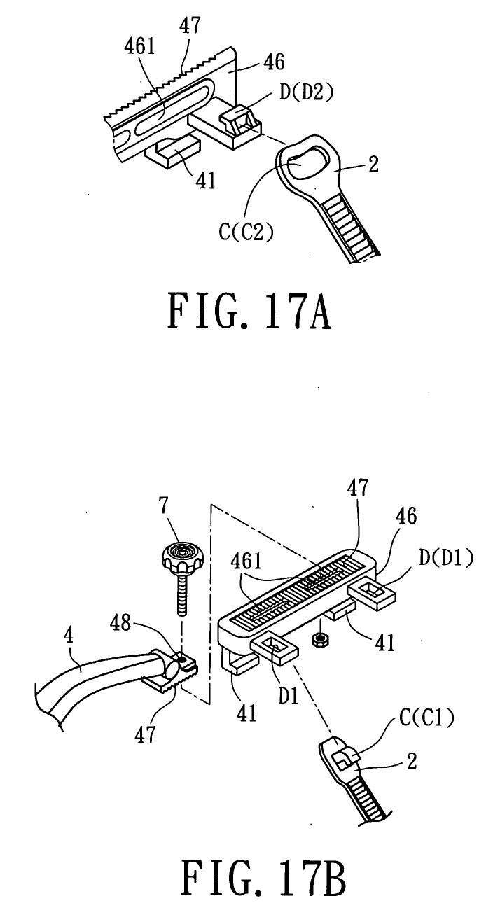

Referring to FIG. 17, two narrow elongated adjustable holder blocks 46 are respectively adjustably fastened to the support arms 4 and locked thereto by a respective lock screw 7. The lock screw 7 is inserted through an elongated sliding slot 461 at one holder block 46 and threaded into a screw hole 48 at one support arm 4 to affix the respective holder block 46 to the respective support arm 4. Further, toothed portions 47 are respectively provided at the free end of each support arm 4 and the back side of each holder block 46 for engagement. By means of adjusting the position of the holder blocks 46 relative to the support arms 4, the total length of the auxiliary rearview mirror is relatively adjusted to fit the size of the vehicle rearview mirror 5.

FIG. 17B is substantially similar to the embodiment shown in FIG. 7 with the exception of the location of the screw hole 48 at each support arm 4.

FIGS. 18 and 18A are substantially similar to FIGS. 17 and 17A with the exception that each holder block 46 has vertical sliding tracks 44 respectively mounted with a respective flexible connecting members 45.

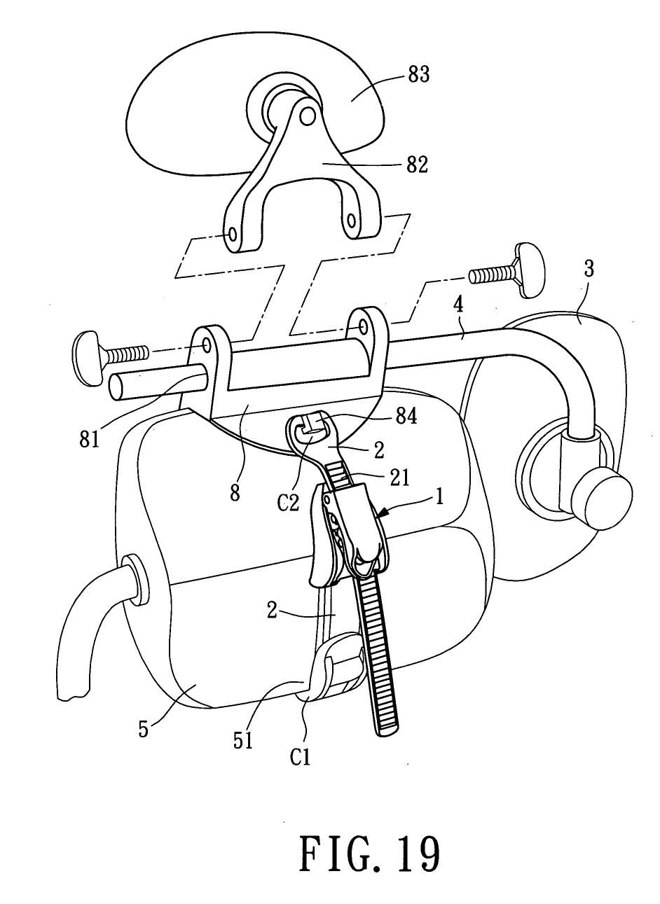

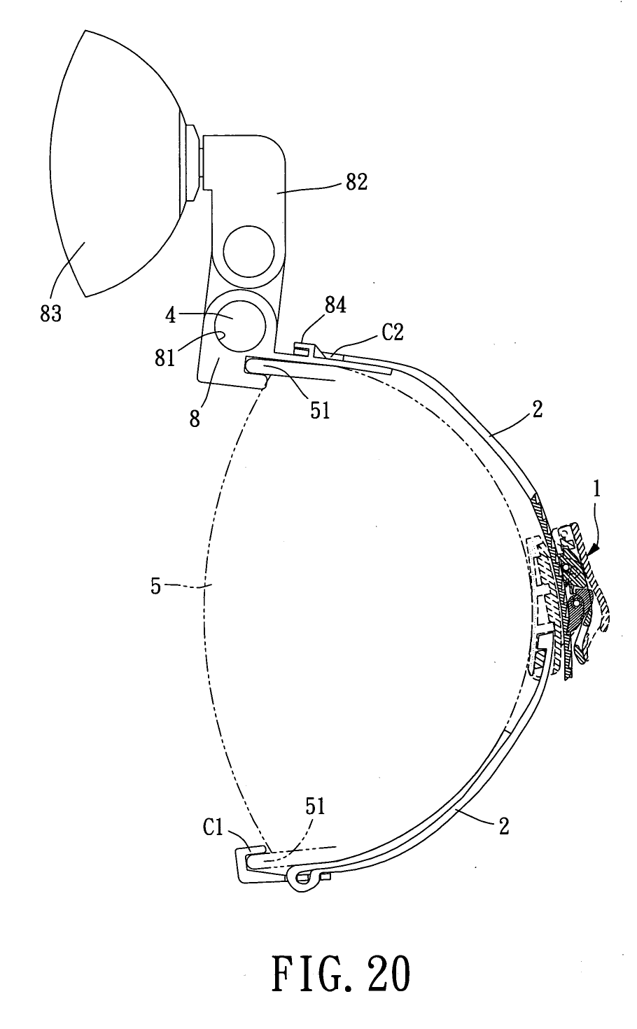

According to the embodiment shown in FIGS. 19 and 20, the auxiliary rearview mirror 3 has only one support arm 4; the vehicle rearview mirror 5 has a mount 8. The mount 8 has a mounting through hole 81, which receives the support arm 4. A wide-angle lens 83 is provided having a back support 82 fastened to the mount 8.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. An auxiliary rearview mirror mounting arrangement comprising an auxiliary rearview mirror, said auxiliary rearview mirror comprising at least one support arm, at least one fastener for fastening said auxiliary rearview mirror to a vehicle rearview mirror, wherein said at least one fastener each comprises
a firs strap, said first strap having a first end and a second end;
a second strap, said second strap having a first end and a second end;
a first connecting member and a second connecting member respectively provided at the first end of said first strap and the first end of said second strap for securing said first strap and said second strap to said at least one support arm of said auxiliary rearview mirror; and
a clip coupled to the second end of said second strap and adjustably clamped on the second end of said first strap to join the second end of said first strap and the second end of said second strap.

2. The auxiliary rearview mirror mounting arrangement as claimed in claim 1, wherein said connecting members of said at least one fastener are hooks.

3. The auxiliary rearview mirror mounting arrangement as claimed in claim 1, wherein said connecting members of said at least one fastener are hook holes.

4. The auxiliary rearview mirror mounting arrangement as claimed in claim 2, wherein said at least one support arm of said auxiliary rearview mirror each has a plurality of hook holes for the connection of the hooks of said connecting members of said at least one fastener.

5. The auxiliary rearview mirror mounting arrangement as claimed in claim 3, wherein said at least one support arm of said auxiliary rearview mirror each has a plurality of hooks for the connection of the hook holes of said connecting members of said at least one fastener.

6. The auxiliary rearview mirror mounting arrangement as claimed in claim 1, wherein said first strap has a plurality of transverse teeth arranged along the length thereof and sloping in one direction; the clip of each said fastener comprises a base frame, which has two front lugs and two rear lugs arranged at two sides, an actuating block, which is pivotally connected between said front lugs and has a front push end for pushing the transverse teeth of first strap forward upon insertion of the second end of said first strap into said clip, an engagement block pivotally connected between said rear lugs for engaging the transverse teeth of said strap to lock said first strap to said clip, and two torsional springs respectively coupled between said base frame and said actuating block and between said base frame and said engagement block to impart a biasing force to said actuating block and said engagement block respectively.

7. The auxiliary rearview mirror mounting arrangement as claimed in claim 6, wherein said clip further comprises a cover pivoted to the said front lugs for covering said engagement block.

8. The auxiliary rearview mirror mounting arrangement as claimed in claim 6, wherein said clip further comprises a cushion block fastened to a bottom side of said base frame.

9. The auxiliary rearview mirror mounting arrangement as claimed in claim 1, wherein said first strap is molded from engineering plastics, and said second strap is molded of rubber.

10. The auxiliary rearview mirror mounting arrangement as claimed in claim 9, wherein said clip comprises a locating ring; said first strap and said second strap are respectively molded from engineering plastics; the second end of said second strap is inserted through the locating ring of said clip and terminating in a flexible endpiece that is stopped at one side of said locating ring.

11. The auxiliary rearview mirror mounting arrangement as claimed in claim 10, wherein said first strap and said second strap each comprise a plurality of transverse teeth arranged along the length thereof and sloping in one direction; said second strap has a slide coupled to the first end thereof, said slide having a spring-supported locking lever for engaging the transverse teeth to lock the slide to the respective strap at the desired location; said second connecting member is formed on said slide.

12. The auxiliary rearview mirror mounting arrangement as claimed in claim 1, wherein said at least one support arm of said auxiliary rearview mirror each comprises at least one L-shaped hooking lug.

13. The auxiliary rearview mirror mounting arrangement as claimed in claim 1, wherein said at least one support arm of said auxiliary rearview mirror each comprises at least one horizontal front insertion hole, at least one vertical rear insertion hole corresponding to said at least one horizontal front insertion holes, at least one vertical sliding track respectively upwardly disposed adjacent to said at least one vertical rear insertion hole, and at least one flexible connecting member for securing the straps of said at least one fastener to said at least one support arm, said at least one flexible connecting member each having a rear end respectively slidably coupled to said at least one vertical sliding track and a front end respectively inserted through said at least one vertical rear insertion hole and then said at least one horizontal front insertion hole of said at least one support arm, and a hook at said rear end for hooking on the rim of a vehicle rearview mirror.

14. The auxiliary rearview mirror mounting arrangement as claimed in claim 1, wherein said auxiliary rearview mirror further comprises at least one holder block respectively coupled to the said at least one support arm for receiving the connecting members of said at least one fastener.

15. The auxiliary rearview mirror mounting arrangement as claimed in claim 14, wherein said at least one holder block each has a toothed portion detachably engaged to a respective toothed portion at said at least one support arm and locked thereto with a respective lock screw.

16. The auxiliary rearview mirror mounting arrangement as claimed in claim 15, wherein said at least one holder block each has an elongated sliding slot for the mounting of said lock screw; said at least one support arm each has a screw hole for receiving said lock screw.

17. The auxiliary rearview mirror mounting arrangement as claimed in claim 14, wherein said at least one holder block each comprises at least one horizontal front insertion hole, at least one vertical rear insertion hole corresponding to said at least one horizontal front insertion holes, at least one vertical sliding track respectively upwardly disposed adjacent to said at least one vertical rear insertion hole, and at least one flexible connecting member for securing the straps of said at least one fastener to said at least one support arm, said at least one flexible connecting member each having a rear end respectively slidably coupled to said at least one vertical sliding track and a front end respectively inserted through said at least one vertical rear insertion hole and then said at least one horizontal front insertion hole of said at least one support arm, and a hook at said rear end for hooking on the rim of a vehicle rearview mirror.
